(19) United States
(12) Patent Application Publication
(10) Pub. No.: US 2003/0110050 A1
(43) Pub. Date: Jun. 12, 2003

(54) Method and system for dynamically providing default offerings for a product

(75) Inventors: Daryl Carvis Cromer, Apex, NC (US); Howard Jeffrey Locker, Cary, NC (US); James Peter Ward, Raleigh, NC (US)

Correspondence Address: International Business Machines Corporation, Intellectual Property Law, Dept. 9CCA/Bldg. 002-2, Personal and Printing Systems Group, P.O. Box 12195, Research Triangle Park, NC, 27709, US

(73) Assignee: International Business Machines Corporation, Armonk, NY

(21) Appl. No.: 10/020,752

(22) Filed: Dec. 12, 2001

(51) Int. Cl. G06F 17/60

(52) U.S. Cl. 705/1

(57) ABSTRACT

A method and system for providing a default offering for a product is disclosed. The product is offered in a plurality of business segments and includes a plurality of components. The method and system include allowing a customer to select at least one business segment of the plurality of business segments. The customer is also allowed to select at least one performance level for at least one of the plurality of components. The method and system also include dynamically determining at least one default offering determined based on the at least one business segment and the at least one performance level.

### FIELD OF THE INVENTION

The present invention relates to computer systems, and more particularly to a method and system for dynamically providing default offerings for a product.

### BACKGROUND OF THE INVENTION

An increasing amount of business is performed remotely, over the Internet. As a result, customers can purchase a variety of products using their computers. FIG. 1 depicts a block diagram of a system 1 that can be used by customers to remotely purchase merchandise. The system 1 includes a business computer system 5 that may include a server or other components and a customer's computer system 10 that can be used by a customer to purchase products remotely. For example, the business computer system 5 may be used to provide a web page accessible to customers. The customer using the customer's computer system 10 may connect to business computer system 5 via the Internet 6. The customer's computer system 10 includes a display 12, input/output devices 14 such as a mouse and/or keyboard, and a processor 16. The computer system 10 typically includes other components which are not shown for clarity.

FIG. 2 depicts a conventional method 50 for allowing customers to purchase products, such as a computer system (not shown), using the system 1. The default offerings and any upgrades are determined, via step 52. A default offering is a particular product, such as a computer system, having certain components and abilities that is provided to the customer for purchase. An upgrade is a feature that can be added to a selected computer system. For example, if the product is a computer system, step 52 typically includes determining a number of components within computer system such as the frames, motherboards, processor, video card, audio card, speaker type, LAN, WLAN, WAN and optical drives to be used in the computer system. The default offerings and upgrades are determined in step 52 independent of customers' visits to the business system 5. These default offerings and upgrades are typically relatively static, remaining unchanged for days or weeks. Thus, one or more default offerings of computer systems having a certain frame, motherboard and processor speed may be determined in step 52. In addition, the available upgrades, such as a better optical drive, are determined. The default offerings are then provided to a customer, via step 54. Because step 52 is decoupled from step 54, there is typically a large delay between step 52 (determining the default offerings and upgrades) and step 54 (providing the default offerings to the customer). Typically, the default offerings are displayed on the display 12 of the computer system 10 in step 54. The customer then selects a desired product, via step 56. The customer generally selects a product from one of the defaults. However, the customer is also allowed to tailor the product instead of selecting from the defaults. Upgrades are also provided to the customer, via step 58. The customer can then select any desired upgrades, via step 60. The purchase may then be completed, via step 60. Step 60 could include matters such as arranging for payment for and delivery of the product.

Although the conventional method 50 allows customers to purchase products using the system 1, there are serious drawbacks. The default offerings provided to a customer dramatically affect whether and what type of product the customer purchases. If the product is a computer system and default offering is a computer system that is too expensive, the customer may terminate the session without purchasing anything. The sale, as well as the customer, may thus be lost. If a customer does purchase something, the item bought is generally the default offering. Thus, if the default offering is a computer system that is too inexpensive, the customer will purchase a computer system that costs less than the customer originally planned on spending. Moreover, if too many choices are available, the customer may overwhelmed and not purchase anything. For example, if too many upgrades are offered, the customer may opt not to upgrade the computer system being purchased. As a result, the business offering the product will earn less than is possible. Consequently, what is needed is a mechanism for automatically tailoring the default offerings to customers.

In determining the default offering, a large number of decisions may be required. Determining the default offerings requires selecting one or a few combinations of components out of a large number of possible combinations. Each default offering includes specific components such as a particular frame, processor, motherboard or other components of a computer system. However, there is typically a large variety of options that can be selected from for each component that can be placed in the default offering. For example, there may be five or more different processor speeds that can be chosen: five hundred MHz, six hundred MHz, seven hundred MHz, eight hundred MHz, nine hundred MHz and one GHz. Similarly, there are typically three different frames that can be chosen: mini-tower, tower and desktop. Consequently, the number of combinations of components that make up the possible default selections is very large. Any mechanism for tailoring the default offering to individual customers would have be take into account this large number possible computer systems and be capable of narrowing the possible computer systems available to the default offering in a timely manner.

Accordingly, what is needed is a system and method for tailoring products offered to a customer to the customer. The present invention addresses such a need.

### SUMMARY OF THE INVENTION

The present invention provides a method and system for providing a default offering for a product is disclosed. The product is offered in a plurality of business segments and includes a plurality of components. The method and system comprise allowing a customer to select at least one business segment of the plurality of business segments. The customer is also allowed to select at least one performance level for at least one of the plurality of components. The method and system also comprise dynamically determining at least one default offering determined based on the at least one business segment and the at least one performance level.

According to the system and method disclosed herein, the present invention provides a mechanism for dynamically providing at least one default offering based on information provided by a customer.

### BRIEF DESCRIPTION OF THE DRAWINGS

FIG. 1 is a diagram of a computer system which is utilized to offer products to a customer.

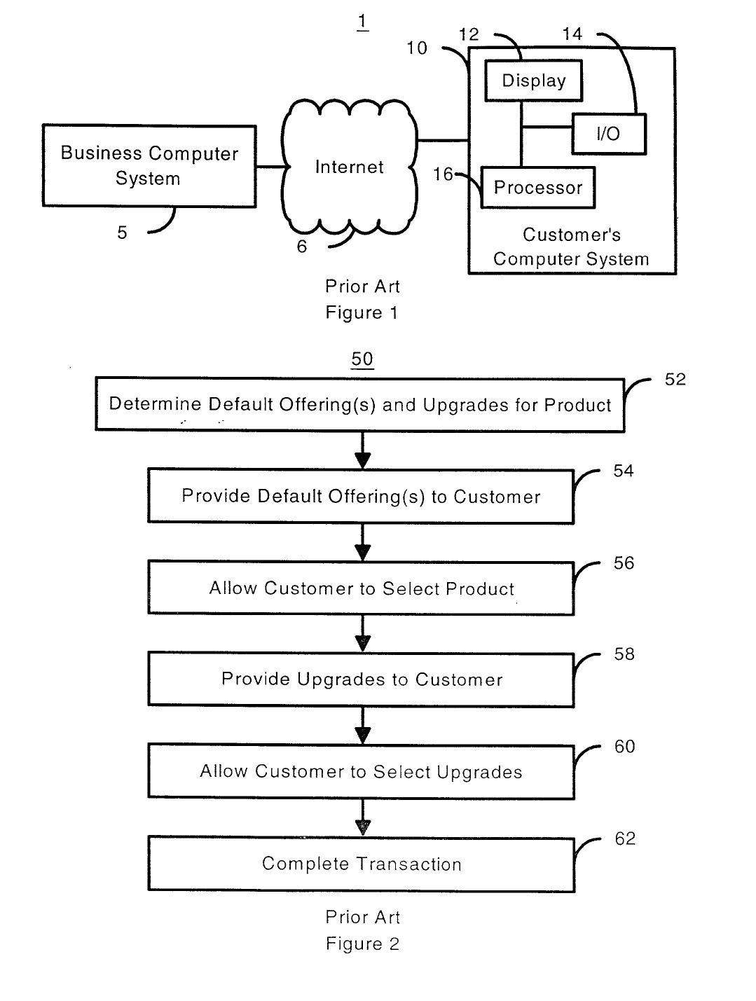

FIG. 2 is a flow chart depicting a conventional method for allowing a user to purchase products on a computer system.

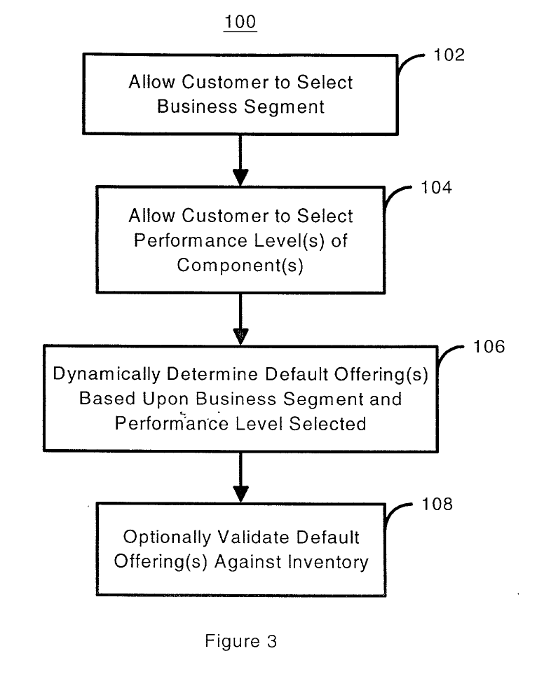

FIG. 3 is a high-level flow chart depicting one embodiment of a method in accordance with the present invention for providing a default offering to a customer via a computer system.

FIGS. 4A and 4B depict a more detailed flow chart of one embodiment of a method in accordance with the present invention for allowing a user to purchase products on a computer system.

### DETAILED DESCRIPTION OF THE INVENTION

The present invention relates to an improvement in determining default offerings for a product. The following description is presented to enable one of ordinary skill in the art to make and use the invention and is provided in the context of a patent application and its requirements. Various modifications to the preferred embodiment will be readily apparent to those skilled in the art and the generic principles herein may be applied to other embodiments. Thus, the present invention is not intended to be limited to the embodiment shown, but is to be accorded the widest scope consistent with the principles and features described herein.

The present invention provides a method and system for providing a default offering for a product. The product is offered in a plurality of business segments and includes a plurality of components. The method and system comprise allowing a customer to select at least one business segment of the plurality of business segments. The customer is also allowed to select at least one performance level for at least one of the plurality of components. The method and system also comprise dynamically determining at least one default offering determined based on the at least one business segment and the at least one performance level.

The present invention will be described in terms of a particular method having certain steps. However, one of ordinary skill in the art will readily recognize that this method will operate effectively with other and/or different steps. Furthermore, the present invention is described in the context of providing a computer system. However, nothing prevents the present invention from being used in conjunction with other products being offered for sale. The present invention is also described in the context of the business sector, performance level and inventory influencing the default offering for a product. However, one of ordinary skill in the art will readily recognize that the present invention is consistent with other and/or additional factors influencing the default offering.

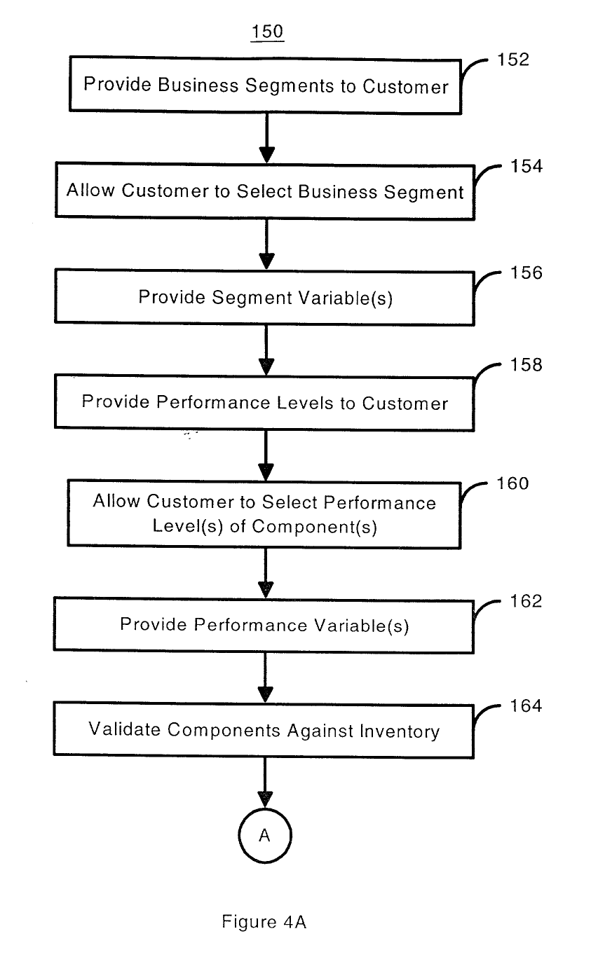

To more particularly illustrate the method and system in accordance with the present invention, refer now to FIG. 3, depicting a high level flow chart of one embodiment of a method 100 in accordance with the present invention for determining default offerings for a product being offered for sale on a computer system. The method 100 is preferably performed using the system 1. The product being offered is preferably a computer system having a plurality of components, such as a frame, a processor, a motherboard and other components. However, nothing prevents the method 100 from being used with another product being offered. The customer is allowed to select a business segment, via 102. For most computer sellers, the business segments are commercial, small business or individual consumers. Step 102 is preferably performed by offering the customer the option of choosing one of the three business segments. The business segment is preferably the first selection made by the customer because the business segment selected affects the remainder of the computer system. For example, an individual consumer who typically uses the computer system at home is generally more interested in multimedia and graphics applications. A customer purchasing a computer system for a small business is generally more interested in the networking capabilities of the computer system. Thus, the components and upgrades in which a customer is typically interested depend upon the business segment of the customer.

The customer is also allowed to select a performance level for one or more of the components, via step 104. In a preferred embodiment, the customer selects a speed for the processor to be provided in the computer system. Thus, step 104 may be performed by displaying a number of possible processor speeds on the display 12 of the computer system 10 and allowing the customer to select between the speeds.

One or more default offerings are dynamically determined based upon the business segment and performance level selected, via step 106. Step 106 preferably includes selecting various components for the computer system based on the business segment and performance levels desired by the customer. Step 106 is performed dynamically because the default offerings are determined based upon the individual consumer's needs and desires as evidenced by the business segment and performance level selections. The default offering is also optionally validated against inventory, via step 108. Step 108 ensures that the default offering can be provided to the customer. If not, then another product having different components could be substituted as the default offering.

The default offering(s) can thus be provided to the customer, preferably by being displayed on the display 12 of the computer system 10. Because the performance level and business segment desired by the customer are known, the default offerings provided using the method 100 are more closely matched to the customers desires. As a result, it is less likely that the default offerings provided will be too expensive to be purchased or less expensive than customer had planned on spending. As a result, the income of the provider of the product may be increased. Furthermore, if the default offering is validated against existing inventory, it is more likely that the product actually selected by the customer can be rapidly shipped to the customer.

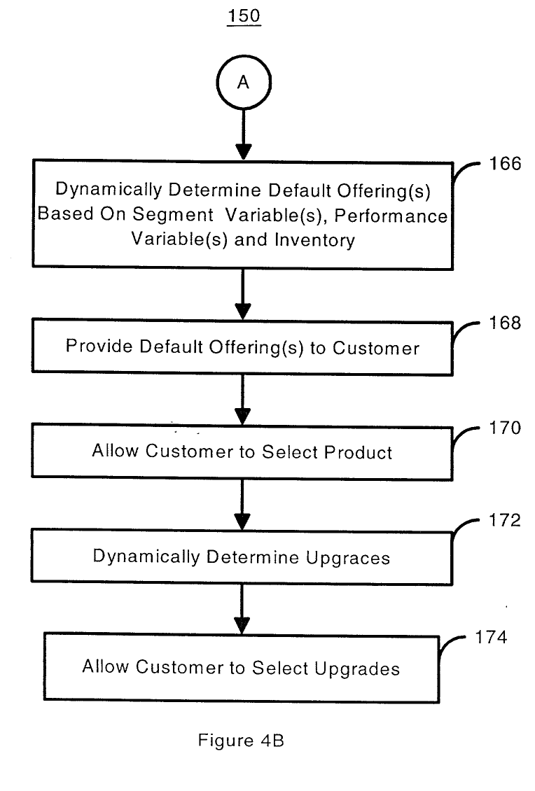

FIGS. 4A and 4B depicts a more detailed flow chart of a method 150 in accordance with the present invention for allowing a user to purchase products on a computer system. The method 150 is preferably performed in conjunction with the system 1. The product being offered is preferably a computer system having a plurality of components, such as a frame, a processor, a motherboard and other components. However, nothing prevents the method 150 from being used with another product being offered. The business segments are preferably provided to the customer, via step 152. Step 152 is preferably performed by displaying the possible business segments for the customer to select between on the computer system 10. The business segments are preferably commercial, small business or individual consumers. The customer is then allowed to select a business segment, via step 154. Based upon the business segment selected, at least one segment variable is provided, via step 156. A segment variable is preferably provided for each component of the computer system. However, in another embodiment, the segment variable could be provided for each of some portion of the components. In a preferred embodiment, the segment variable for a particular component varies between 0.1 and 1.0. A segment variable of 0.1 indicates that the component is typically not needed or desired for the particular business segment. A segment variable of 1.0 indicates that the component typically must be included for the particular business segment. For example, if the individual consumer business segment is selected, components such as video cards, audio cards, speakers or optical devices preferably have a segment variable of 0.8 to 1.0. However, if the commercial business segment is selected in step 154, then commercially oriented products such as LAN or Ethernet devices have a segment variable in the range of 0.8 to 1.0, while modems have a segment variable in the range of 0.1 to 0.2.

A plurality of performance levels for one or more components of the product are provided to the customer, via step 158. In a preferred embodiment, step 158 is performed by displaying the available processor on the display 12. Each of the processors has a particular speed and thus a particular level of performance. The customer selects the performance level for one or more of the components, via step 160. Preferably, step 160 is performed when the customer selects the processor.

Performance variables are provided based on the level of performance selected, via step 162. In a preferred embodiment, the performance variable is a rating based upon the speed of the processor. If the processors can be considered to be n, n+1, n+2, . . . , n+i, with n having the lowest speed and n+i having the highest speed, then the performance variable are preferably from 0.1 to 1, where each value is correlated to one of n, n+1, n+2, . . . , n+i. For example, the performance value of 0.1 may correlate to a processor speed n. The remaining components having a matching performance variable might be selected as part of the default offering or as an upgrade. For example, if the performance variable for the processor is n, then a video card with a performance variable of n might be selected as part of the default offering or as an upgrade.

The components for the product are also validated against existing inventory, via step 164. Step 164 is preferably performed by providing inventory variables for the components that may be placed in the default offering. In a preferred embodiment, step 164 is performed by checking the inventory for the components and providing an inventory variable of between 0.1 and 1.0 for each component. However, the inventory variables could be provided for a portion of the components of the product. An inventory variable of 0.1 indicates that the item is low on stock, while an inventory variable of approximately 1.0 indicates that the item is available.

One or more default offerings for the product are dynamically determined using the segment variables, the performance variables and the inventory variables, via step 166. Step 166 is preferably performed by multiplying the segment variable, inventory variable and, where applicable, performance variable for each decision required in providing the default offering. For example, if the product being offered is a computer system and a particular frame is to be provided in the default offering, then the variables will be multiplied for each frame type. The frame type (mini-tower, tower or desktop) having the highest score is made part of the default offering. If multiple default offerings are to be provided, then lower scores may be made part of the other default offerings. Thus, the default offerings can be built component by component in step 166.

The default offering is provided to the customer, via step 168. In a preferred embodiment, step 168 is performed by providing one or more default offering to the display 12 of the computer system 10 from the system 5. The customer selects a product, via step 170. Typically, the customer would select a default offering. However, the customer is also allowed to individually select components of the computer system.

Upgrades are dynamically determined, via step 172. In a preferred embodiment, the upgrades are dynamically determined using previous selections by the customer. Thus, for each selection made by the customer, the upgrades to be offered are updated. In a preferred embodiment, the upgrades are determined by matching the segment and performance variables of a subsequent upgrade to that of the first upgrade selected. For example, if the customer selected a video card having performance variable of x (where x is preferably from 0.1 to 1.0) and the customer has selected the individual consumer business segment, then the upgrade for an optical drive would be determined to be one with a performance variable of x and in the individual consumer business segment. The upgrades are provided to the consumer, via step 174.

Thus, the default offerings and upgrades are dynamically determined based on a few selections by the customer. As a result, the default offerings and upgrades are more tailored to each individual consumer. Thus, it is less likely that the default offerings provided will be too expensive to be purchased or less expensive than the customer had planned on spending. The income of the provider of the product may be increased. Moreover, because the components are validated against inventory, it can be assured that the default product being offered can be built rapidly.

A method and system has been disclosed for dynamically determining a default offering for a product. Software written according to the present invention is to be stored in some form of computer-readable medium, such as memory, CD-ROM or transmitted over a network, and executed by a processor. Consequently, a computer-readable medium is intended to include a computer readable signal which, for example, may be transmitted over a network. Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

What is claimed is:

1. A method for providing a default offering for a product, the product being offered in a plurality of business segments and including a plurality of components, the method comprising the steps of:
(a) allowing a customer to select at least one business segment of the plurality of business segments;
(b) allowing the customer to select at least one performance level for at least one of the plurality of components;
(c) dynamically determining at least one default offering determined based on the at least one business segment and the at least one performance level.

2. The method of claim 1 further comprising the steps of:
(d) providing at least one segment variable based upon the at least one business segment; and
(e) providing at least one performance variable based upon at least one of the plurality of segment variables.

3. The method of claim 2 wherein the dynamically determining step (c) further includes the step of:
(c1) dynamically calculating at least one score based on the at least one segment variable and the at least one performance variable to provide the at least one default offering.

4. The method of claim 3 wherein the dynamically determining step (c) further includes the step of:
(c2) determining the at least one default offering based upon a maximum score calculated using the at least one segment variable and the at least one performance variable.

5. The method of claim 1 wherein the step of allowing the customer to select at least one business segment (a) further includes the step of:
(a1) providing a portion of the plurality of business segments to the customer.

6. The method of claim 1 wherein the step of allowing the customer to select at least one performance level (b) further includes the step of:
(b1) providing a plurality of performance levels to the customer.

7. The method of claim 1 further comprising the step of:
(d) validating a portion of the plurality of components against an inventory to determine whether the portion of the plurality of components is available.

8. The method of claim 7 wherein the dynamically determining step (c) further includes the step of:
(c1) dynamically providing the at least one default offering determined based on the at least one business segment, the at least one performance level and a determination of whether the portion of the plurality of components is available.

9. The method of claim 1 further comprising the step of:
(d) providing a default upgrade to the customer based upon the at least one default offering.

10. A computer-readable medium containing a program for providing a default offering for a product, the product being offered in a plurality of business segments and including a plurality of components, the program including instructions for:
(a) allowing a customer to select at least one business segment of the plurality of business segments;
(b) allowing the customer to select at least one performance level for at least one of the plurality of components;
(c) dynamically determining at least one default offering determined based on the at least one business segment and the at least one performance level.

11. The computer-readable medium of claim 10 wherein the program further includes instructions for:
(d) providing at least one segment variable based upon the at least one business segment; and
(e) providing at least one performance variable based upon at least one of the plurality of segment variables.

12. The computer-readable medium of claim 11 wherein the dynamically determining instructions (c) further includes instructions for:
(c1) dynamically calculating at least one score based on the at least one segment variable and the at least one performance variable to provide the at least one default offering.

13. The computer-readable medium of claim 12 wherein the dynamically determining instructions (c) further includes instructions for:
(c2) determining the at least one default offering based upon a maximum score calculated using the at least one segment variable and the at least one performance variable.

14. The computer-readable medium of claim 10 wherein the instructions for allowing the customer to select at least one business segment (a) further includes instructions for:
(a1) providing a portion of the plurality of business segments to the customer.

15. The computer-readable medium of claim 10 wherein the instructions for allowing the customer to select at least one performance level (b) further includes instructions for:
(b1) providing a plurality of performance levels to the customer.

16. The computer-readable medium of claim 10 wherein the program further includes instructions for:
(d) validating a portion of the plurality of components against an inventory to determine whether the portion of the plurality of components is available.

17. The computer-readable medium of claim 10 wherein the dynamically determining instructions (c) further includes instructions for:
(c1) dynamically providing the at least one default offering determined based on the at least one business segment, the at least one performance level and a determination of whether the portion of the plurality of components is available.

18. The computer-readable medium of claim 10 further comprising instructions for:
(d) providing a default upgrade to the customer based upon the at least one default offering.

19. A computer system programmed to provide a default offering for a product, the product being offered in a plurality of business segments and including a plurality of components, the computer system comprising:
a display;
an input/output device, the display and the input/output device for allowing a customer to select at least one business segment of the plurality of business segments and to select at least one performance level for at least one of the plurality of components;
a processor, coupled with the input/output device, for dynamically determining at least one default offering determined based on the at least one business segment and the at least one performance level.
